(19) United States
(12) Patent Application Publication
(10) Pub. No.: US 2003/0129353 A1
(43) Pub. Date: Jul. 10, 2003

(54) Computer mouse pad fabricated from patterned flock or pile fibers

(75) Inventor: L. Brown Abrams, Fort Collins, CO (US)

Correspondence Address: SHERIDAN ROSS PC, 1560 BROADWAY, SUITE 1200, DENVER, CO, 80202

(73) Assignee: High Voltage Graphics, Inc.

(21) Appl. No.: 10/371,640

(22) Filed: Feb. 21, 2003

Related U.S. Application Data
(63) Continuation-in-part of application No. 09/548,839, filed on Apr. 13, 2000.
Application No. 09/548,839 is a continuation-in-part of application No. 29/058,551, filed on Aug. 19, 1996.

(51) Int. Cl. B32B 3/02

(52) U.S. Cl. 428/88; 428/90

(57) ABSTRACT

A plush fiber mousepad is disclosed, and its method of manufacture is defined. The plush fiber mousepad is continuously made from a process of electrostatically flocking a release material, and adding a binder to the release material, fusing the binder to a base material such as a textile fabric, and removing the release material to expose the plush surface, and then laminating the textile material to a rubber base sheet, through the application of a hit melt film, with the lamination step taking place either before or after the electrostatic application of the plush fiber to the textile base material.

### CROSS-REFERENCE TO RELATED APPLICATIONS

The present application is a continuation of U.S. patent application Ser. No. 09/548,839, filed Apr. 13, 2000, entitled “COMPUTER MOUSE PAD FABRICATED FROM PATTERNED FLOCK OR PILE FIBERS AND METHOD OF FABRICATION”, which is a continuation-in-part of U.S. Design patent application Ser. No. 29/058,551, filed Aug. 19, 1996, each of which is incorporated herein by this reference.

### BACKGROUND OF THE INVENTION

Field of the Invention

Mousepads have been fabricated using a variety of methods. In the most common method, a high density plastic or fabric “mousing surface” is adhered with glue to a foam substrate. Those mousepads which have the plastic or fabric sheet on top eventually come apart from the base, usually looking ragged at the corners first, and eventually no longer function. Other methods employ natural materials, such as leather, as both the “mousing surface” and underside of the mousepad. These materials are expensive to obtain, and do not function optimally for use as mousepads.

### BRIEF SUMMARY OF THE INVENTION

The present invention generally relates to a method of manufacturing a mousepad with flock appliques. Specifically, the invention is directed to methods of manufacturing flock transfers which exhibit superior mousepad surface performance, particularly flock transfers composed of a plurality of precolored flock. More particularly, the present invention is directed to improved decorative appliques manufactured from a continuous roll of rubber aligned with textile and a hot melt film, the pattern transferred directly on the aligned rubber and textile, heat fused together and die cut to form a mouse pad.

### BRIEF DESCRIPTION OF THE SEVERAL VIEWS OF THE DRAWINGS

In the drawings, FIG. 1 is a cross-sectional view of the flock transfer of the invention;

FIG. 2 is a cross-sectional view of the flock transfer of the invention being applied to a surface;

FIG. 3 is a perspective view of an automated mouse pad manufacturing assembly;

FIG. 4 is a top plan view of a mouse pad of the present invention;

FIG. 5 is a view in side elevation of the mouse pad;

FIG. 6 is a front plan view of the mouse pad; and

FIG. 7 is an exploded view of the components of an alternative embodiment of the method of making a mousepad.

### DETAILED DESCRIPTION OF THE INVENTION

As shown in FIG. 1, the transfer 2 of the present invention comprises a dimensionally stable paper sheet 4 to which a conventional flock transfer release adhesive 6, usually silicone wax, is applied in the reverse of a desired pattern, that is a pattern which corresponds to the overall image which is to be flocked. In the preferred embodiment, the pattern is a simple rectangle. The flock 8 which may be rayon or any other type of conductive material such as nylon, polyester or the like is applied to the activated adhesive 6 by conventional electrostatic means or gravity.

In order to achieve a multicolor effect the flock 8 is applied through a gauze-like mesh screen. The different colors are achieved by using different color flock. As each color is applied a different screen is used which only allows penetration of the particular colored flock onto its section of the release adhesive 6. Since the flock is not printed with ink following flocking as in a conventional multicolor transfer, the length of the flock can be substantially increased to 1 mm as opposed to the conventional 0.3 mm. Thus, the transfer is much more plush, vivid and three dimensional.

The lower ends of flock 8 are coated with a binder adhesive 10 such as a water based acrylic I which binds the flock into a unit. The binder 10 may contain an additional adhesive, a hot melt, for binding the transfer to a substrate. In the referred embodiment, natural rubber acts as the substrate. In the alternative, the hot melt adhesive 12, usually a granular polyester or nylon, may form a separate layer. The use of separate hot melt layers is preferable.

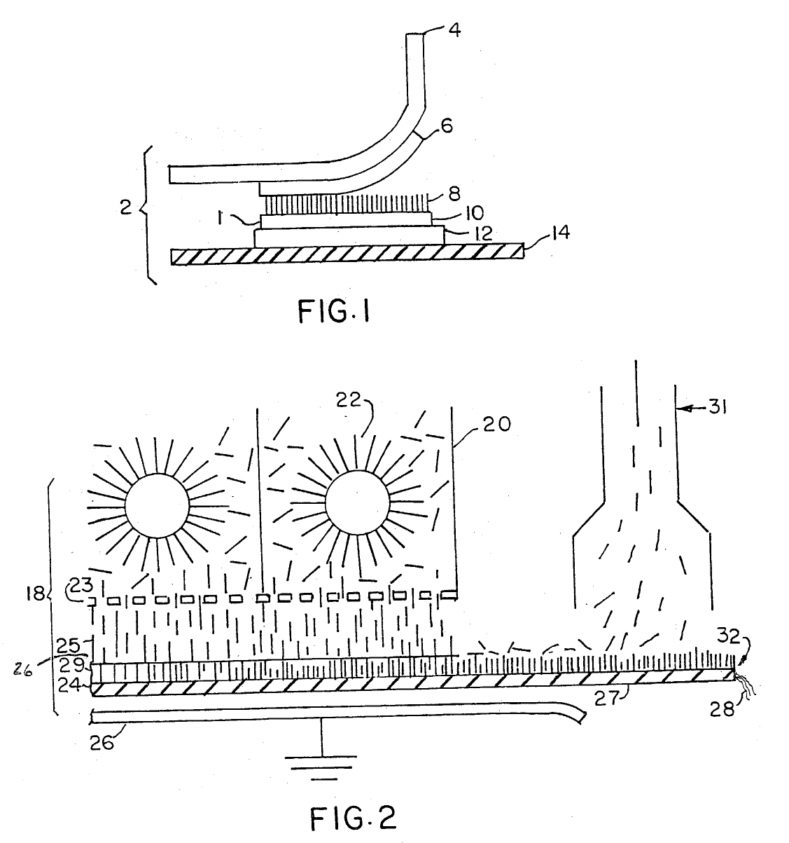

FIG. 2 illustrates the application of the transfer to a surface. The hot melt surface 12 is placed against the rubber 14. Heat and pressure is applied to the release sheet 4 in order to bond the transfer to the rubber surface. The release sheet 4 with the adhesive 6 is then pulled away from the flock 8. This leaves a transfer permanently affixed to the rubber surface.

More specifically, flock fibers are dosed or dispensed from a hopper or box 20 by being physically pushed through a dispensing screen 23, which is preferably made of metallic mesh, by means of a rotating dosing brush 22, down into the electrostatic field and through barrier 29. The barrier 29 has an open section corresponding to a predetermined pattern of flock to be passed therethrough. The barrier 29, which is preferably a mesh screen, may also be referred to herein as the image screen. As shown, the image screen is located between the dispensing screen 23 of the hopper and rubber substrate material 27. Preferably, the image screen is positioned closely adjacent the rubber substrate material and more preferably is spaced from the substrate material by a distance which is about equal to the length of flock being applied to the substrate, and most preferably by a distance of about 110% of the length of the flock. In the most preferred instance, the binding adhesive is preferably applied to the substrate material to a thickness equal to less than about 10% of the length of the flock. The metallic dosing screen is connected to a high voltage source and is itself the high voltage electrode 23 giving the flock fibers a charge, either positive or negative. The charged fibers are then attracted to the counter potential, i.e., the screen 29 and adhesive 24 below the screen. Fibers 8 are propelled by electrostatic counter potential attraction toward the grounded electrode, and they either then contact the screen and reverse polarity and are then propelled again towards the electrode screen or, if they are propelled into the adhesive 24, they become permanently lodged in it and remain there, eventually forming the flock coating on the adhesive coated rubber substrate material 27. In accordance with the present invention, the flock becomes polarized, taking on both the charge of the electrode on one end and the counter potential charge on the other so it is no longer oscillating in the electrostatic field.

The resultant flock has a electrically conductive chemical finish coating to enable it to become charged as well as to enable it to continually change charges back and forth from positive to negative thousands of times per minute. Thus the flock oscillates back and forth between the electrode, i.e., the dosing screen, and the ground 30 until it eventually finds a permanent location in the adhesive. The amount of flock therefore dosed into the electrostatic field is adjusted to be roughly equal to the amount which is taken out of the field or used by the printed adhesive, to avoid overdosing or crowding of the fibers in the field which may block the image screen or simply waste the flock. Up to 100,000, volts is used with very low amps, e.g., a maximum of 200 microamps with about 40,000 volts being preferred. The textile applications, 1 millimeter nylon flock with 3.3 Dtex (diameter) is preferred. A vacuum 31 removes any residual flock not bound to substrate 27 by adhesive.

The individual mouse pads are die cut from the larger finished flock and rubber bonded combination. Since the fibers are specially treated with a conductive finish, in use they help ground the mouse by drawing static electricity away.

The present invention utilizes the general materials and flocking techniques found in U.S. Pat. Nos. 3,793,050; 4,292,100; and 4,396,662 and UK patent application Nos. 2,065,031 and 2,126,951 all of which are incorporated by reference herein. Although the invention utilizes conventional materials and techniques which can be generally found in various prior art references, the particular combination of elements of the present invention produces a unique and superior flock transfer.

An example of the method of producing the mousepads of the invention comprises:

(1) a release adhesive such as a silicone wax layer 6 in the reverse of a predetermined pattern is applied to a dimensionally stable base sheet 4, such as, a bond paper.

(2) A first color of rayon flock 8 is passed through a monofilament polyester screen for ten to fifteen seconds through an electrostatic field. The screen has open sections in those areas which correspond to the first colored section of the reversed design. The upper ends 25 of flock 8 are imbedded in the layer 32 since the wax acts as a ground for the charged particles.

(3) This procedure is then followed for each succeeding color of rayon flock 8 that is to be electrostatically flocked in order to form the desired design. The unit is then dried.

(4) The lower ends 26 of the exposed flock 8 are printed using conventional screen printing equipment with a water based acrylic binder 10 (40%-60% water). The binder 10 binds the flock 8 and further provides opacity and brilliance by reflecting light.

(5) The binder 10 is powdered with a nylon polyester hot melt adhesive 12. The transfer is then dried overnight.

(6) After brushing and vacuuming excess adhesive 12 the transfer is placed in an infrared dryer to cross link the binder 10 and adhesive 12.

(7) To apply the transfer to a rubber base 14, the adhesive surface 12 is positioned on the rubber base 14. Heat and pressure (5-60 seconds at 300-350 degrees F.) is applied to the paper 4. The transfer is allowed to cool and the paper 4 and wax 6 are removed by peeling the paper 4 from the flock 8.

The desired flock design is thus permanently affixed to the rubber base.

In the processing and manufacturing of the sheets of material that ultimately form the mouse pad of this invention, separate rolls of base rubber, and a textile, may be unwound off of their respective rolls and adhered together by a hot melt adhesive. The hot melt adhesive may be formed as a film, and arranged intermediate the two materials as they are unwound, to provide for their adhesive connection together. After the transfer has been fabricated (as described above with respect to FIGS. 1 and 2), the transfer can be continuously applied to the textile either before or after the textile is adhered to the base. When subsequently all of these laminates, including the base rubber, the textile, the textile with the flock transfer applied to it, are laminated together, and subject to whatever heat is required to provide for the blending of these components into an adhesively connected state, the continuous length of consolidated material may be subject to dye cutting, to the dimensions required and desired for forming the mouse pad of this invention. Following this, fringe material may be applied to the edges of the pad, if desired, to provide the mouse pad with the decorative effect sought for the end and finished product.

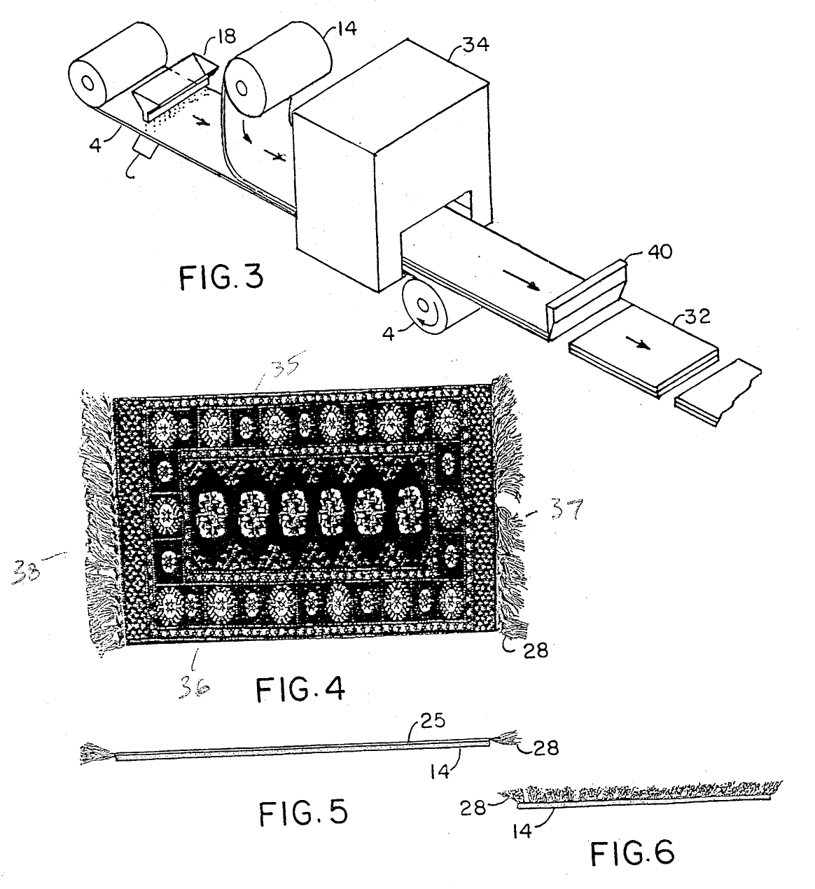

It is desirable to automate the process for manufacturing mouse pads. Referring now to FIG. 3, a continuous roll of release material 4 with associated transfer release adhesive 6 passes across the flocking assembly 18 where fibers are embedded into the release material 4 through transfer release adhesive 6 to produce a continuous transfer. A continuous roll of rubber base material 14 with associated binder 10 is laid over the surface of the release material 4, and heated in drying oven 34 until the fibers are fused onto the surface of rubber base material 14 through the binder 10. Release sheet material 4 is then peeled away. A cutting knife or sectioner 40 cuts the individual mousepads 32.

In the preferred embodiment of the present invention, patterns of oriental rugs are created by scanning images of real hand-woven rugs, digitizing and outputting the art files used in the fiber coating process In this way all the irregularities and imperfections are reproduced to make the finished product look like a miniature version of a hand made rug.

Referring to FIGS. 4 and 5, the mousepad surface is substantially rectangular, having longer sides 35 and 36, and shorter sides 37 and 38. The mousepad 32 can have fringe 28 added to the shorter sides 37 and 38 for aesthetic reasons. It is preferable to add the fringe 28 at the interface of flock 8 and rubber base 14.

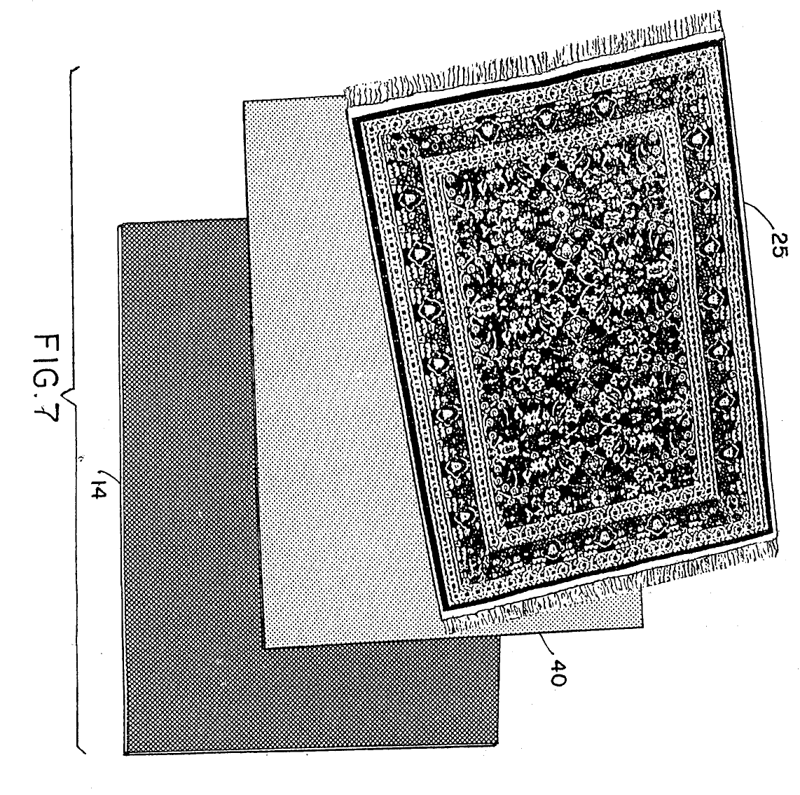

Referring now to FIG. 7, an alternative method of making the mousepad of the present invention is shown by way of illustrating the component parts of the mousepad. Top portion 25 is formed to an appropriate size. It is preferred that the top surface portion 25 is composed of fibers flocked onto material, and cut to the desired size. An appropriately sized intermediate heat seal film 40 is then placed at the interface between fibers 25 and rubber base 14. The intermediate heat seal film 40 has approximately the same area as the top surface portion 25. Heat is applied until the heat seal film 40 permanently bonds the fibers 25 to the rubber base 14.

It is believed that the advantages and improved results furnished by the methods and products of the present invention are apparent from the foregoing description of the preferred embodiment of the invention. Various changes and modifications may be made without departing from the spirit and scope of the invention as described in the claims that follow.

What is claimed is:

1. A computer mouse pad, comprising:
a pad assembly, including:
a flocked surface for operatively engaging a computer mouse; and
a rubber base adhered to the flocked surface;
wherein the pad assembly has opposing peripheral edges; and
a fringe material engaging the opposing peripheral edges.

2. The computer mouse pad of claim 1, wherein the rubber base is adhered to the flocked surface by an adhesive.

3. The computer mouse pad of claim 1, wherein the pad assembly has two pairs of opposing peripheral edges and the fringe material engages only one of the two pairs of opposing peripheral edges.

4. The computer mouse pad of claim 1, wherein the flocked surface comprises multiple colors of flock arranged in a predetermined pattern.

5. The computer mouse pad of claim 1, wherein the flocked surface comprises a plurality of flock fibers oriented substantially perpendicular to the rubber base.

6. The computer mouse pad of claim 1, wherein the fringe material is oriented transversely to flock fibers in the flocked surface.

7. The computer mouse pad of claim 1, wherein the fringe material extends outwardly from each of the opposing peripheral edges.

8. The computer mouse pad of claim 6, wherein the flock fibers are oriented transversely to the plane of a top surface of the rubber base, wherein the fringe material comprises a plurality of fringe segments extending outwardly from each of the opposing peripheral edges, and wherein the fringe segments are oriented transversely to the flock fibers.

9. The computer mouse pad of claim 2, wherein the adhesive is a hot melt adhesive.

10. The computer mouse pad of claim 2, wherein the adhesive is activatable.

11. The computer mouse pad of claim 9, wherein the adhesive comprises one of polyurethane, polyester, and nylon.

12. The computer mouse pad of claim 10, wherein the activatable adhesive comprises a pressure sensitive adhesive.

13. The computer mouse pad of claim 10, wherein the activatable adhesive is a heat seal film.

14. The computer mouse pad of claim 10, further comprising a binder adhesive and wherein the binder adhesive is a water-based acrylic adhesive and the activatable adhesive is a hot melt adhesive.

15. A computer mouse pad, comprising:
a pad assembly, including:
a flock layer for operatively engaging a computer mouse; and
a rubber base adhered to a lower surface of the flock layer; and
a fringe material engaging peripheral edges of the pad assembly.

16. The computer mouse pad of claim 15, wherein the rubber base is adhered to the flock layer by an adhesive.

17. The computer mouse pad of claim 15, wherein the pad assembly has two pairs of opposing peripheral edges and the fringe material engages only one of the two pairs of opposing peripheral edges.

18. The computer mouse pad of claim 15, wherein the flock layer comprises multiple colors of flock arranged in a predetermined pattern.

19. The computer mouse pad of claim 15, wherein the flock layer comprises a plurality of flock fibers oriented substantially perpendicular to the rubber base.

20. The computer mouse pad of claim 15, wherein the fringe material is oriented transversely to flock fibers in the flock layer.

21. The computer mouse pad of claim 15, wherein the fringe material extends outwardly from each of the opposing peripheral edges.

22. The computer mouse pad of claim 20, wherein the flock fibers are oriented transversely to the plane of a top surface of the rubber base, wherein the fringe material comprises a plurality of fringe fibers extending outwardly from each of the opposing peripheral edges, and wherein the fringe fibers are oriented transversely to the flock fibers.

23. The computer mouse pad of claim 16, wherein the adhesive is a hot melt adhesive.

24. The computer mouse pad of claim 16, wherein the adhesive is activatable.

25. The computer mouse pad of claim 24, wherein the adhesive comprises one of polyurethane, polyester, and nylon.

26. The computer mouse pad of claim 24, wherein the activatable adhesive comprises a pressure sensitive adhesive.

27. The computer mouse pad of claim 24, wherein the activatable adhesive is a heat seal film.

28. The computer mouse pad of claim 24, further comprising a binder adhesive and wherein the binder adhesive is a water-based acrylic adhesive and the activatable adhesive is a hot melt adhesive.

29. A method for using a computer mouse, comprising:
providing a computer mouse pad, the computer mouse pad including a flocked surface for operatively engaging the computer mouse, a rubber base adhered to the flocked surface, and a fringe material projecting outwardly from peripheral edges of the rubber base;
engaging an underside of the computer mouse with the flocked surface; and
moving the computer mouse over the flocked surface.

30. The method of claim 29, wherein the mouse comprises a track ball, the track ball being in contact with the flocked surface and rotating during the receiving step.

31. The method of claim 29, wherein the rubber base is adhered to the flocked surface by an adhesive.

32. The method of claim 29, wherein the mousepad comprises two pairs of opposing peripheral edges and the fringe material engages only one of the two pairs of opposing peripheral edges.

33. The method of claim 29, wherein the flocked surface comprises multiple colors of flock arranged in a predetermined pattern.

34. The method of claim 29, wherein the flocked surface comprises a plurality of flock fibers oriented substantially perpendicular to the rubber base.

35. The method of claim 29, wherein the fringe material is oriented transversely to flock fibers in the flocked surface.

36. The method of claim 29, wherein the fringe material extends outwardly from each of the opposing peripheral edges.

37. The method of claim 29, wherein the flock comprises a plurality of flock fibers oriented transversely to the plane of a top surface of the rubber base, wherein the fringe material comprises a plurality of fringe segments extending outwardly from each of the opposing peripheral edges, and wherein the fringe segments are oriented transversely to the flock fibers.
